(19) United States
(12) Patent Application Publication
(10) Pub. No.: US 2012/0256100 A1
(43) Pub. Date: Oct. 11, 2012

(54) Device for Reading Storage Films

(75) Inventors: Herbert Haentsch, Beilstein (DE); Bernd Phillips, Untergruppenbach (DE); Michael Weber, Burgstetten (DE)

(73) Assignee: DUERR DENTAL AG, Bietigheim-Bissingen (DE)

(21) Appl. No.: 13/437,208

(22) Filed: Apr. 2, 2012

(30) Foreign Application Priority Data
Apr. 11, 2011 (DE) 10 2011 016 601.7

(51) Int. Cl. G01N 21/64

(52) U.S. Cl. 250/458.1; 250/200

(57) ABSTRACT

In a reading device for reading storage films, a reading light beam rotating about an axis of rotation is directed onto the storage film through a reading opening of a film support. Fluorescent light returning from the storage film falls through the reading opening into a photodetector. Misreadings produced by reflected secondary reading light are reduced by the provision of a filter at the reading opening, which filter allows at least some fluorescent light to pass and attenuates reading light reflected from the storage film.

### RELATED APPLICATIONS

This application claims priority to German Patent Application No. 10 2011 016 601.7 filed on Apr. 11, 2011, the entirety of which is incorporated herein.

### FIELD OF THE INVENTION

The invention relates to a reading device for reading storage films, in which a reading light beam, which preferably rotates about an axis of rotation, is directed onto the storage film through a reading opening of a film support, and fluorescent light returning from the storage film falls through the reading opening into a photodetector.

### TECHNICAL FIELD AND BACKGROUND OF THE INVENTION

Such a reading device is generally known from DE 199 42 211 C2.

In the medical and dental field or in non-destructive testing as well as in safety engineering, X-ray storage films are at present frequently used instead of conventional X-ray films, which X-ray storage films contain storage centres which are excitable by X-ray light. By exposure to X-ray light, the storage centres will be excited into a metastable state, so that a latent image in the form of excited and non-excited storage centres is produced. If reading light of a predetermined wavelength then falls onto the excited storage centres, they begin to emit fluorescent light, so that the latent image can be made visible.

Reading devices of the type mentioned at the beginning, which are also called scanners, are used to read the latent image from a storage film which has previously been exposed to X-ray light or other radiation and, for example, to display the image on a screen.

To that end there is produced, for example, a rotating reading light beam which scans the storage film along a line and excites metastable storage centres to fluoresce. By advancing the storage film in a direction perpendicular to the direction of rotation of the laser, or by moving the scanning line itself, a relative movement between the storage film and the scanning line is produced, so that the storage film is scanned line by line or point by point. The fluorescent light emitted thereby is converted by a photodetector into an electrical signal, the amplitude of which corresponds to the number of excited storage centres at the point that is being read. The image signals obtained on scanning are processed together with pairs of position signals for the angular position of the reading light beam and the advance of the storage film to form an electronic image of the latent image.

It is an object of the invention to further reduce the image errors of a reading device of the type described at the beginning.

### BRIEF DESCRIPTION OF THE PRESENT INVENTION

According to the present invention, the object may be achieved by providing at the reading opening a filter which allows at least part of the fluorescent light returning from the storage film to pass and attenuates reading light reflected by the storage film.

It has been recognised that part of the reading light which falls through the reading opening onto the storage film is reflected at the storage film and enters the interior of the reading device again through the reading opening. This reflected reading light can strike the storage film again in other areas of the reading opening and can there excite any metastable storage centres present to fluoresce. As a result, points of the storage film that are not yet to be scanned are excited to fluoresce, resulting in premature erasure of the latent X-ray image at that point and crosstalk between different image regions. Overall, therefore, the general background signal increases and/or the resolution is impaired.

In order to prevent the reflected reading light from entering the interior of the reading device again, as small a reading opening as possible should therefore be provided. However, this has the result that less fluorescent light is also able to pass through the reading opening and into the photodetector.

By means of the measures according to the invention, however, the reading opening can nevertheless be chosen to be sufficiently large that a very large part of the emitted fluorescent light can fall into the photodetector. This is because, owing to the filter, the reading opening appears smaller for the reading light reflected from the storage film than for the fluorescent light, so that less reflected reading light in other areas of the reading opening is able to excite storage centres that are not yet to be scanned.

According to an embodiment of the present invention, the reflected reading light is substantially blocked.

Although better results are already achieved by a slight attenuation of the reflected reading light, complete blocking thereof ensures that the storage film is activated only by the reading light beam.

According to another embodiment of the present invention, the filter has, at least in a region, selectively absorbing material which absorbs reading light to a greater extent than it does fluorescent light.

The filtering action of the filter can be achieved by material which is dichroic in the volume, but also by special anti-reflection coatings which have directional transmission. Preference is given to the use of materials which absorb selectively in the volume, as are used in colour filters, in which the reading light is converted into heat by the absorption and is removed as such from the system. Alternatively, it is also possible to use cut-off filters, which can have interference coatings, for example.

According to still another embodiment of the present invention, the filter has a passage region which is transparent both for fluorescent light and for reading light.

Owing to the passage region, the primary reading light can fall unhindered onto the storage film.

According to a further embodiment of the present invention, the passage region of the filter is free of material.

The filter accordingly corresponds to a type of aperture or slit diaphragm, the diaphragm material of which is a selectively absorbing material. Because there is no material in the passage region, the reading light falls onto the storage film with maximum intensity. In addition, no material-related scattering effects occur in the passage region, so that the diameter of the excited spot corresponds well with the diameter of the reading light beam.

Typically, a filter has a constant thickness perpendicular to the transmission direction. However, filters with varying thickness can also be provided. In particular, a filter can be provided which tapers from the passage region to the edges of the reading opening in order to keep the influence on the fluorescent light as small as possible.

According to still another embodiment of the present invention, the passage region is bounded on at least one side, preferably on two opposing sides, by selectively absorbing material.

Although advantages according to the invention are already obtained if selectively absorbing material is provided on only one side of the passage region, the arrangement of filter material on both sides has the advantage that the fluorescent light emitted by the point of the storage film that is being read is influenced symmetrically.

According to an embodiment, the reading device is a slot.

In the case of a reading opening in the form of a slot, the reading light beam can rotate. Rotation of the reading light beam can be effected mechanically in a particularly simple and precise manner, so that a line is read cleanly point by point.

According to another embodiment, the film support is at least part-cylindrical and the reading opening is formed extending in the peripheral direction in the film support.

The cylindrical shape of the film support allows the reading light beam to strike the storage film perpendicularly at any point of the storage film, so that the same geometric reading conditions prevail at each point.

According to another embodiment, the filter is annular and is arranged in the reading opening.

The arrangement of a filter ring in the circumferential reading opening represents a simple production step. In the case of a material-free passage region, filter rings of a selectively absorbing material can be arranged on both sides of the reading opening.

According to another embodiment, there is provided at least one mirror, which directs fluorescent light to the photodetector and is preferably arranged coaxially with respect to the axis of rotation of the reading light beam.

By means of a mirror, which can be in the form of a plane or concave mirror, which is located opposite the photodetector, or in the form of an annular mirror, which surrounds the photodetector, a very large part of the fluorescent light is guided into the photodetector.

According to another embodiment, the mirror(s) is/are coated with a selectively absorbing material layer which is transparent for fluorescent light, or reflects it, and absorbs reading light.

As a result, residual scattered reading light is additionally absorbed inside the reading device, without the fluorescent light being attenuated.

According to another embodiment, the filter is formed by an edge limb of the material layer, which edge limb extends to the middle of the reading opening.

This represents a simple production possibility, because no further structural elements have to be provided.

According to another embodiment, the filter carries an anti-reflection coating which reflects a small amount of reading light in the case of perpendicular incidence and reflects a large amount of reading light in the case of oblique incidence.

Because the reading light passes perpendicularly through the reading opening at each point, an anti-reflection coating with pronounced angle-dependent transmissibility can ensure that reading light reflected diffusely, and accordingly also obliquely, by the storage film does not enter the interior of the reading device again, or does so in only an attenuated manner.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

An exemplary embodiment of the invention is explained in more detail below with reference to the following drawings.

FIG. 1 is a perspective view of a scanner, in which the scanning unit has been removed.

FIG. 2 is a perspective view of the scanning unit with a reading laser arranged parallel to the axis.

FIG. 3 is a longitudinal section through the scanner in the region of a reading opening according to an embodiment in which the reading laser is arranged radially.

FIG. 4 is a longitudinal section through the scanner in the region of the reading opening.

FIG. 5 is a longitudinal section in the region of the reading opening according to another embodiment.

FIG. 6 is a longitudinal section in the region of the reading opening according to a further embodiment.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

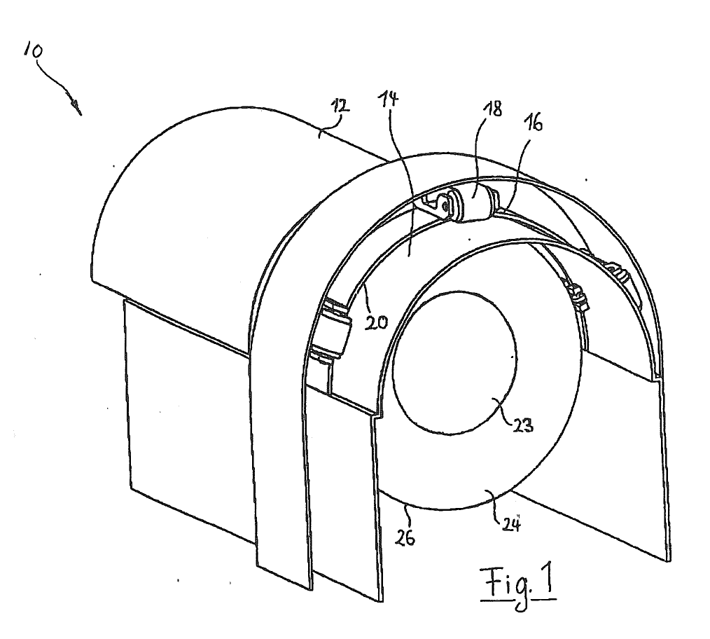

FIG. 1 shows a scanner, designated 10 as a whole, for a flexible storage film 12, with which it is possible to read from the storage film 12 a latent image produced in the storage film 12 on irradiation of an object with X-radiation or other short-wave electromagnetic radiation or corpuscular radiation.

The storage film 12 has the form of a rectangular sheet and comprises a flexible plastics substrate with a light-sensitive layer comprising phosphor particles which are embedded in a transparent matrix and which contain storage centres mostly in the form of atoms of rare earths.

During illumination, the storage centres are excited to a metastable state under the action of the radiation, whereby the latent image forms in the storage film 12.

The scanner 10 comprises a part-cylindrical curved film carrier 14 on which the storage film 12 lies. A transport device 16 having three drive units 18 in the form of belt conveyors spaced along the periphery engages with the convex outer side of the curved storage film 12 and moves the storage film 12 in the axial direction of the film carrier 14 over a reading opening 20 in the form of a slot, which is provided extending in the circumferential direction on the film carrier 14.

Inside the reading device 10 there is arranged on the centre axis of the circular cylindrical curved surface of the film carrier 14 a photomultiplier 22 as the photodetector, the entry window 23 of which is located perpendicularly on the centre axis of the film carrier 14.

The entry window 23 is surrounded by a concave annular mirror 24, the outer periphery 26 of which ends close to the reading opening 20 on one side thereof.

Opposite the photomultiplier 22 and the annular mirror 24 with respect to the plane of the reading opening 20, the reading device 10 has a scanning unit 28, which produces a rotating reading light beam 30.

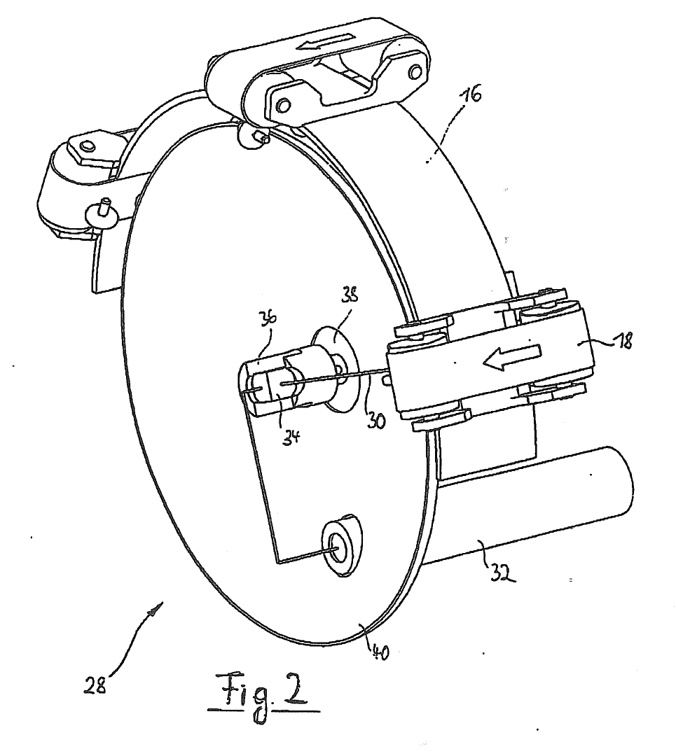

To that end, the scanning unit 28 has as the reading light source a rod laser 32 arranged parallel to the axis, which rod laser 32 produces the reading light beam 30 with a wavelength, which in practice is in the red range, of from approximately 620 nm to approximately 670 nm and with a diameter of several μm. The reading light beam 30 is deflected by means of two 45° deflecting mirrors (not shown in FIG. 2) onto the centre axis of the film carrier 14, the reading light beam 30 running on the centre axis away from the photomultiplier 22.

The scanning unit 28 further has a drive motor 38, the drive shaft of which is arranged on the centre axis of the film carrier 14. A prism holder 36 which points in the direction towards the photomultiplier 22 and which carries a deflecting prism 34 is mounted on the drive shaft. The deflecting prism 34 is so arranged that the reading light beam 30, which falls onto the deflecting prism from the front (from the left in FIG. 2), is deflected radially outwards. Corresponding to the rotation of the drive motor 38, the reading light beam 30 thereby rotates about the centre axis of the film carrier 14, the conditions being so chosen that the plane of rotation of the reading light beam 30 is coincident with the mid-plane of the reading opening 20. The reading light beam 30 can thus emerge from the reading opening 20 radially outwards, in order to strike the inwardly facing light-sensitive layer of the storage film 12 perpendicularly from the inside.

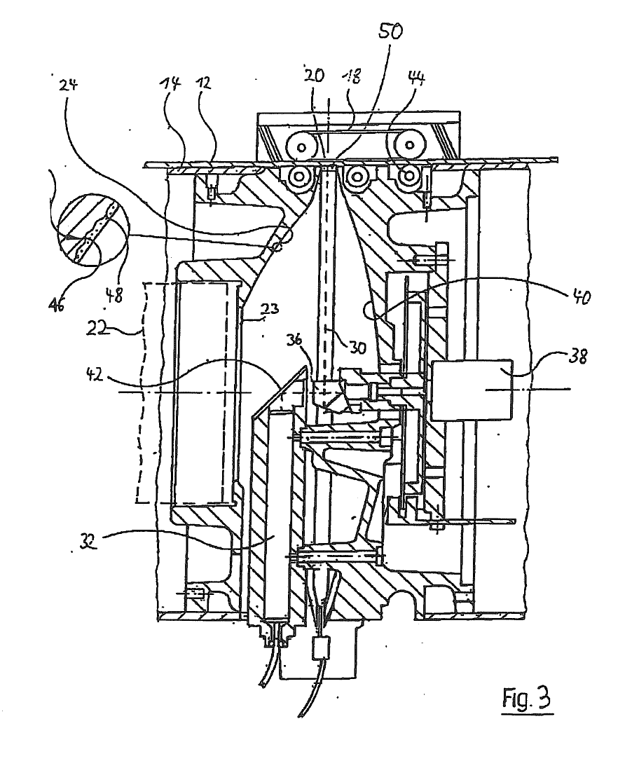

Behind the prism holder 36 there is provided a convex mirror 40 having corresponding openings for the drive shaft of the drive motor 38 and for the rod laser 32, which convex mirror 40 directs fluorescent light 21 having a wavelength in the range of from approximately 390 nm to approximately 450 nm entering through the reading opening 20 onto the entry window 23 of the photomultiplier 22, as will be seen analogously from FIG. 3. With the exception of the arrangement of the rod laser, FIG. 3 can also be used in conjunction with FIGS. 1 and 2.

FIG. 3 shows a slightly modified embodiment in which the rod laser 32 is not arranged axially in the reading device 10 but is oriented radially, from beneath in the drawing, on the centre axis. As a result, only one 45° deflecting mirror 42 is necessary, which directs the reading light beam 30 onto the deflecting prism 36.

In this embodiment, the opposing concave mirrors 24 and 40 form the reading opening 20 directly and terminate flush with the film carrier 14. Opposite the drive units 18 there are arranged rollers 44 at the edges of the mirrors 24 and 40, over which rollers 44 the storage film 12 runs so that the wear of the storage film 12 at the reading opening 14 is low.

As is clear from the enlargement in FIG. 3, the mirror surfaces 46 of the mirrors 24 and 40 are roughened, so that a diffuse reflection of the light is produced. Furthermore, the mirror surface 46 is provided with a coating 48 of a selectively absorbing material. The coating 48 absorbs reading light but is transparent for the fluorescent light 21, so that only the fluorescent light 21 is reflected at the mirror surfaces 46 and can fall into the entry window 23 of the photomultiplier 22.

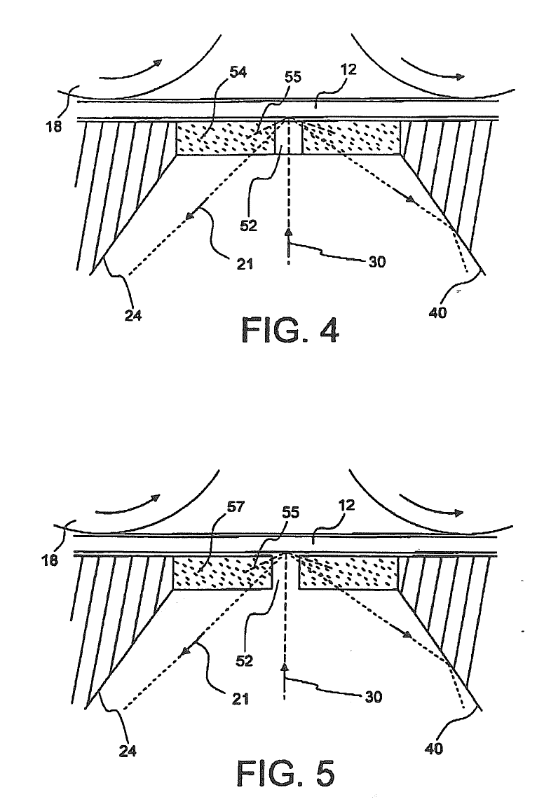

As is shown in FIG. 4, a filter 50 is located at the reading opening 20, which filter 50 follows the course of the reading opening 20 in the circumferential direction. The filter 50 has in its centre a passage region 52 which is transparent for reading light and through which the reading light beam 30 falls onto the storage film 12. The passage region 52 is bounded on both sides, on the left and right in FIG. 4, by absorption regions 54 of selectively absorbing material. Secondary reading light 55 reflected by the storage film 12 is absorbed in the absorption regions 54, as is indicated in FIG. 4 by the coarse broken lines ending in the absorption regions 54.

However, the fluorescent light 21 produced by the relaxing storage centres in the storage film 12 is able to pass unhindered through the absorption regions 54 into the interior of the reading device 10, as is indicated by the fine broken lines. There, the light is reflected at the two mirrors 24 and 40 and is finally converted in the photomultiplier 22 into an image signal for an image pixel.

The filter 50 has the effect that, for secondary reading light 55 reflected by the storage film 12, the reading opening 20 appears to have the only small dimensions of the passage region 52. However, the fluorescent light 21 that is produced is able to pass through the entire reading opening 20 into the interior of the scanner 10, as a result of which the light yield and accordingly the signal of the photomultiplier 22 is improved. Accordingly, the passage region 52, which is only small, prevents the reflected reading light 55 from exciting storage centres in other areas of the reading opening 20, for example in other areas of the periphery, before they are scanned, which would lead to falsification of the image signal.

FIG. 5 shows an embodiment in which two filter rings 57 of selectively absorbing material are arranged in the reading opening 20 on the mirrors 24 and 40, or the film support, on both sides in such a manner that a material-free gap remains between them as the passage region 52, which is delimited by the end faces of the filter rings 57 facing one another.

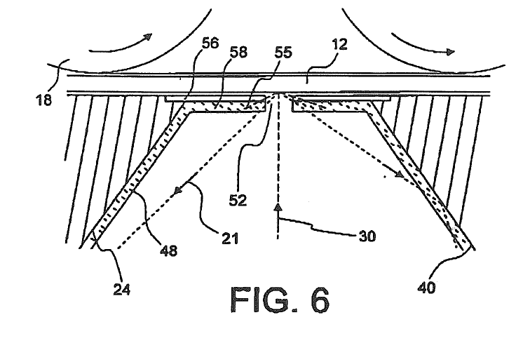

FIG. 6 shows an embodiment in which transparent sleeves 56 are arranged on the mirrors 24 and 40, which sleeves 56 project at the edges of the mirrors 24 and 40 into the reading opening 20, a material-free passage region 52 being left between the sleeves 56. The coating 48 of selectively absorbing material is thereby applied both to the mirrors 24 and 40 and to the sleeves 56, so that projecting edge limbs 58 of the selectively absorbing material are formed and produce the filtering action at the reading opening 20. Accordingly, a separate component is not required as the filter 50 for narrowing the reading opening 20 for reflected reading light 55.

In another embodiment (not shown), the filter 50 comprises a sleeve which is transparent both for fluorescent light 21 and for reading light and which carries an anti-reflection coating. The anti-reflection coating is so designed that a maximum transmission coefficient is present for the reading light beam 30 which strikes the filter 50 perpendicularly, which transmission coefficient falls rapidly as the angle of incidence becomes greater. As a result, the obliquely reflected reading light 55 is thrown back onto the storage film 12 again and is there able to read excited storage centres that remain in the reading point currently being scanned.

Because the fluorescent light 21 has a different wavelength than the reading light, the anti-reflection coating can be so designed that the fluorescent light is influenced only negligibly. The anti-reflection coating can be arranged on the transparent sleeve on one side on the side facing the storage film 12 or on the side remote from the storage film 12, or on both sides.

In a variation, the above-described filter 50 can also be used in the case of non-cylindrical reading devices such as flat-bed scanners or galvo scanners.

In a further variation, a different photodetector such as, for example, a photodiode can be provided instead of the photomultiplier 22.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

Claimed is:

1. A reading device for reading storage films comprising:
a reading light beam movable along a given path over a storage film; and,
a fluorescent light returning from the storage film which falls onto a photodetector,
wherein along at least part of the given path there is provided a filter which allows at least part of the fluorescent light returning from the storage film to pass and attenuates reading light reflected by the storage film.

2. The reading device according to claim 1, further comprising:
the filter substantially blocking the reflected reading light.

3. The reading device according to claim 1, further comprising:
the filter including, in at least a region, a selectively absorbing material which absorbs reading light to a greater extent than it does fluorescent light.

4. The reading device according to claim 1, further comprising:
the filter including a passage region which covers at least part of the given path and which is transparent both for fluorescent light and for reading light.

5. The reading device according to claim 4, wherein the passage region of the filter is free of material.

6. The reading device according to claim 4, wherein the passage region is bounded by the selectively absorbing material on at least one side.

7. The reading device to claim 1, further comprising:
a reading opening of a film support is a slot.

8. The reading device to claim 1, further comprising:
a film support is at least part-cylindrical and a reading opening thereof is formed extending in the circumferential direction in the film support.

9. The reading device according to claim 8, wherein the filter is annular and is arranged in the reading opening.

10. The reading device to claim 1, further comprising:
at least one mirror which directs fluorescent light to the photodetector and is arranged coaxially with respect to an axis of rotation of the reading light beam.

11. The reading device according to claim 10, wherein each mirror is coated with a selectively absorbing material layer which is transparent for fluorescent light, or reflects fluorescent light, and absorbs reading light.

12. The reading device according to claim 11, wherein the filter is formed by an edge limb of the material layer, and the edge limb extends to a middle of a reading opening.

13. The reading device according to claim 1, wherein the filter has an optical layer structure which reflects a small amount of reading light in a case of perpendicular incidence and reflects a large amount of reading light in a case of oblique incidence.
